(19) United States
(12) Patent Application Publication
(10) Pub. No.: US 2013/0204922 A1
(43) Pub. Date: Aug. 8, 2013

(54) Asset Control and Management System

(71) Applicants: Amr Saad El-Bakry, Houston, TX (US); Kelly E. Becker, Sugar Land, TX (US); Mark L. Crawford, Houston, TX (US); Bryce A. Holloway, Easton, PA (US); Glenn O. Morrell, Houston, TX (US); Pawel K. Peczak, Basking Ridge, NJ (US); Limin Song, West Windsor, NJ (US); Adam K. Usadi, Basking Ridge, NJ (US)

(72) Inventors: Amr Saad El-Bakry, Houston, TX (US); Kelly E. Becker, Sugar Land, TX (US); Mark L. Crawford, Houston, TX (US); Bryce A. Holloway, Easton, PA (US); Glenn O. Morrell, Houston, TX (US); Pawel K. Peczak, Basking Ridge, NJ (US); Limin Song, West Windsor, NJ (US); Adam K. Usadi, Basking Ridge, NJ (US)

(21) Appl. No.: 13/814,903

(22) PCT Filed: Jul. 25, 2011
(86) PCT No.: PCT/US11/45230

§ 371 Date: Feb. 7, 2013

Related U.S. Application Data
(60) Provisional application No. 61/405,827, filed on Oct. 22, 2010.

(51) Int. Cl. H04L 29/08

(52) U.S. Cl. CPC H04L 67/10
USPC 709/202

(57) ABSTRACT

An embodiment provides a method for managing a hydrocarbon asset. The method includes creating an interactive community of agents, wherein each agent comprises code and functional data structures configured to direct a processor to access resource on a network. At least one of the agents is configured to be a workflow agent, wherein the work-flow agent is configured to pursue a plan to accomplish a goal. The work-flow agent is provided with sensors to determine environmental conditions. The workflow agent is provided with the ability to communicate with other intelligent agents. The workflow agent is configured to select the plan based, at least in part, on information obtained from the sensors.

### CROSS-REFERENCE TO RELATED APPLICATION

This application claims the benefit of U.S. Provisional Patent Application 61/405,827, filed Oct. 22, 2010, entitled ASSET CONTROL AND MANAGEMENT SYSTEM, the entirety of which is incorporated by reference herein.

### FIELD

Embodiments of the present techniques relate to a method and system for control of assets. Specifically, an embodiment provides an agent based system for obtaining information about the assets.

### BACKGROUND

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

The physical system of an oil or gas asset involves a complex network of hydrocarbon reservoirs, a collection of injection and production wells, pipeline networks, gathering and processing facilities, transportation vessels, and markets. A key feature in every node in this network is the presence of uncertainty, particularly in reservoirs and markets. Control and management of such assets involves a complex system of activities that comprises distributed, and often interacting, workflows or business processes that integrate hierarchical layers of sensing, control, and decision units. Examples of objects from the sensing layers include sensors, such as downhole gauges, wellhead sensors, and persons entering manually obtained data. At the control layer, valves may be used to control fluid flows in systems such as artificial list systems, water injection systems, and compressors, among others. Decisions may be made at a high level based on the data from the sensors to implement changes to controls, such as valves. Examples of decision-making units include operators, reservoir engineers, surface engineers, production geologists, asset supervisors, asset managers, and government officials, among others. These personnel may be combined into an asset management team. As used herein, an asset management team is used to denote a group of professionals, including, for example, engineers, operators, geophysicists, asset managers, and others, that are involved in the management of an asset.

Asset management teams may be formed of individuals with diverse technical and managerial skill sets. In addition, the team members may have significantly different degrees of experience in managing such assets. Team members can make decisions based on a combination of historical experience and information from different asset components, such as reservoirs, wells, surface facilities, and external entities, such as markets or other parts of the company or organization. Team members may often seek the expertise from experienced professionals within the company who are external to the asset management team. Multiple asset level members are often involved in a given business process or workflow, implicitly or explicitly. Asset level teams are functionally, and may be geographically distributed. Within asset-management teams, there is a decentralized ownership of the tasks, information, and resources involved in the work process. Asset-management team members are relatively autonomous between coordination meetings organized by asset-management team supervisors. They have their own data sources, data bases, analysis tools, information systems, with their own relevant asset representation. They have also their own resources and tools to manage those resources. There is a high degree of natural concurrency, and, thus, many interrelated tasks are running at any given point of the work processes. For optimal asset performance, there is a need to monitor and manage the overall work process for the whole asset. Although the control and resources of the constituent sub-work processes are decentralized, there is often a need to either achieve an asset-level goal or to place asset-level constraints on the entire process, e.g., total available gas, total budget, etc. Further, the goals of various asset-management teams may be interrelated, for example, an asset management team for a refinery may request changes in production rates from an asset management team for a reservoir or a group of reservoirs.

However, reservoirs are highly dynamic and pose a high degree of uncertainty. Accordingly, it is difficult to give a complete a priori specification of all the activities that need to be performed to achieve a goal and how they should be scheduled. Any detailed time plans which are produced may be disrupted by unavoidable delays or unanticipated events, such as slugging wells, facility downtime, production rate changes, and unexpected increases in liquid ratios, among others.

In addition to the complications discussed above, energy companies may experience periods of high turnover in personnel. Accordingly, increasingly complex assets may be managed by younger and less experienced asset-level team members.

To make optimal decisions concerning assets, all relevant data should be available at the right time, analyzed with the best available analysis tools and scrutinized by the best available expertise. However, these conditions may be difficult to achieve. For example, experienced personnel may not be available to the team, or even recognized as needed by the team. Further, data obtained for assets may be substantial, complicating the identification of pertinent points in a timely fashion. For these reasons, providing pertinent, consistent, and current data with the right interpretation at the right time to the appropriate asset-management team member may be problematic.

This task is particularly challenging in complex assets. As used herein, complex assets denotes assets with many components to manage, such as multiple reservoirs, reservoirs with multiple wells, assets in remote areas and geographically challenging locations, or assets with challenging and highly dynamic behavior, such as assets focused on the distribution of hydrocarbons to markets.

Another major challenge in managing assets arises from the fact that different asset-management team members may have different goals, which may conflict. For example, one team member may have the goal of extending the lifespan of a reservoir, which can indicate moderate production rates over a long period, while another team member may have the goal of maximizing cash flow from the reservoir, which may indicate high production over the short term. Team members may follow different workflows, and may focus on different time scales for achieving their goals. Further, such workflows are often executed in parallel and in many cases they are often dependent on each other. Computer aided techniques for enhancing decision making for asset management have generally focused on providing simulations, history matching, or other low level analytical results.

International Patent Application Publication No. WO2009094064 by Meurer, et al., discloses methods, computer-readable mediums, and systems that analyze hydrocarbon production data from a subsurface region to determine geologic time scale reservoir connectivity and production time scale reservoir connectivity for the subsurface region. Compartments, fluid properties, and fluid distribution are interpreted to determine geologic time scale reservoir connectivity and production time scale reservoir connectivity for the subsurface region. A reservoir connectivity model based on the geologic time scale and production time scale reservoir connectivity for the subsurface region is constructed, wherein the reservoir connectivity model includes a plurality of production scenarios each including reservoir compartments, connections, and connection properties for each scenario. Each of the production scenarios is tested and refined based on production data for the subsurface region.

P. J. Vrolijk, et al., “Reservoir Connectivity Analysis—Defining Reservoir Connections and Plumbing”, SPE Middle East Oil and Gas Show and Conference, Kingdom of Bahrain (2005), provides that gas, oil, and water fluids in channelized or faulted reservoirs can create complex reservoir plumbing relationships. Variable hydrocarbon contacts can develop when some, but not all, fluids are in pressure communication. Reservoir Connectivity Analysis (RCA) is a series of analyses and approaches to integrate structural, stratigraphic, and fluid pressure and composition data into permissible but non-unique scenarios of fluid contacts and pressures. RCA provides the basis for fluid contact and pressure scenarios at all business stages, allowing the creation of fluid contact and segmentation scenarios earlier in an exploration or development setting, and the identification of by-passed pays or new exploration opportunities in a production setting. Combining conventional structural and fault juxtaposition spill concepts with a renewed appreciation of fluid breakover (contacts controlled by spill of pressure-driven, denser fluid, like water over a dam) and capillary leak (to define the ratio of gas and oil where capillary gas leak determines the gas-oil contact (GOC)), permissible but non-unique scenarios of the full fluid fill/displacement/spill pathways of a hydrocarbon accumulation are defined comprising single or multiple reservoir intervals.

Other tools have more specifically focused on higher level views. For example, U.S. Pat. No. 6,216,098 to Clancey, et al., discloses methods and apparatus for modeling behavior. A computer model includes an agent having one or more beliefs, a world model, and facts. Behavior is modeled by frames including workframes modeling time-consuming portions of an activity or thoughtframes modeling non-time-consuming portions of an activity or information processing. Detectables model acquisition of, and response to, information during a defined portion of an activity. A detectable tests facts to form beliefs of the agent, which can affect continued performance of the activity. The model is run by selecting for each time one of the frames to be the working frame, maintaining a context of active frames representing activities that are underway at any time, and performing the working frame until it completes or another frame is selected to be performed in its place. Another frame may be selected when a detectable effect causes an impasse in the working frame or completes or aborts the working frame, or a higher-priority frame interrupts the working frame. In another aspect, the invention provides the services of an intelligent agent. An agent model models a user with a general component modeling an idealized agent having the role or tasks of the user and a situation-specific component describing the state and the beliefs of the user. The agent model is run under the control of a comparator process both in a forward-looking mode to generate predictions and in an explanatory mode to compare predictions generated by the agent model with actions of the user.

U.S. Pat. No. 7,266,456 to DeGuzman, et al., discloses a method for the management of multiple wells in a reservoir. The method includes setting production and performance goals for each individual well and monitoring the performance of each individual well. Each individual well is enabled to assess its own situational state and enable socially interactive corrective actions, including enabling collaboration and cooperation among the wells, such that the wells share with each other their situational states, goals, and plan data. Remediation strategies are developed and refined for problems detected within the wells. Execution of the remediation strategies may be performed either independently, or by operator intervention. The remediation strategies may be applied to each individual well. The goals may be revised and reset, and pattern recognition and machine learning may be integrated into the proceeding steps.

Huhns, M., et al., “Agents on the Web—Workflow Agents,” IEEE Internet Computing, July-August 1998, discuss the use of agents to manage workflows. These agents include, for example, user agents, resource agents, and brokers. Each of the agents described have a distinct role in managing resources. The agents can negotiate with each other and with resource agents to meet global constraints. However, while agents manage parts of workflows, no agents are dedicated to single workflows.

Ashri, R., et al., “From SMART to agent systems development,” Eng. Appl. Artif. Intell., 18, 2 (March 2005), pp. 129-140, discuss agent-oriented software engineering. The paper deals with the issue of individual agent specification and construction, departing from the conceptual basis provided by the smart agent framework. Smart offers a descriptive specification of an agent architecture but omits consideration of issues relating to construction and control. In response, the authors introduce two new views to complement smart: a behavioral specification and a structural specification. Together, these two specifications determine the components that make up an agent and how they operate.

Ashri, R., et al., “Architectures for negotiating agents,” Proceedings of the 3rd Central and Eastern European Conference on Multi-Agent Systems (Prague, Czech Republic, Jun. 16-18, 2003), V. Ma\check{r}ík, M. Pechou\check{c}ek, and J. Müller, Eds. Lecture Notes In Artificial Intelligence (Springer-Verlag, Berlin, Heidelberg, 2003), 136-146, discusses issues relating to the construction of negotiating agent architectures. Automated negotiation is gaining interest, but issues relating to the construction of negotiating agent architectures have not been addressed sufficiently. Towards this end, the authors present an agent construction model that enables the development of a range of agent architectures based on a common set of building blocks. They identify fundamental components needed for two generic classes of negotiating agents: simple negotiators and argumentative negotiators, and use the model to describe them. They note that the model allows them to reuse fundamental components across these negotiation architectures.

### SUMMARY

An embodiment provides a system for managing hydrocarbon assets. The system includes a computer network associated with a hydrocarbon asset and a plurality of agents operating on the computer network, wherein at least one agent in the plurality of agents is a workflow agent. The workflow agent includes an operating code configured to direct the operation of the agent, a goal to be accomplished for the hydrocarbon asset, and a plan to accomplish the goal, wherein the plan is selected by the workflow agent based, at least in part, on a current condition. The workflow agent includes a data store of conditions.

The plurality of agents may include any one or any combinations of an asset agent configured to represent the data for the hydrocarbon asset, a personal agent configured to access other agents to obtain information and analysis results for a user, or a plurality of personal agents. Each of the plurality of personal agents can be associated with a member of an asset-management team, and the plurality of personal agents may be configured to interact to achieve a goal. A new workflow agent may be instantiated by the plurality of personal agents. The plurality of agents may be arranged in a hierarchy of agents operating at different levels of functionality.

Further, the plurality of agents may include an explainer. The explainer can be configured to format results from an analysis and to provide the formatted results of the analysis to another software agent or to a human. The explainer can be configured to recommend actions for managing the hydrocarbon asset.

The plurality of software agents may include a simulator agent. The simulator agent may include a reservoir model and the reservoir model may include surface facilities. The simulator agent can be configured to interact with a history matching agent.

The system may include a wide-area network coupling a plurality of facility networks. An agent can be configured to interact with another agent located at a customer facility.

A workflow agent may compete with other agents for resources and can be configured to negotiate with other agents to fulfill goals. If the workflow agent is unable to fulfill a goal, it can be configured to communicate with a personal agent in order to engage human intervention.

Another embodiment provides a method for managing a hydrocarbon asset. The method includes creating an interactive community of agents, wherein each agent includes code and functional data structures. At least one workflow agent can be created, wherein the workflow agent is configured to pursue a plan to accomplish a goal. The workflow agent is provided with detectors to determine environmental conditions and the ability to communicate with other intelligent agents. The workflow agent is configured to select the plan based, at least in part, on information obtained from the detectors.

The method may include providing an analysis agent configured to coordinate a plurality of sensor readings and determine a status of a system. A personal agent may be provided configured to access other agents to obtain information and analysis results for a user. A personal agent may be configured to interact with other personal agents and with other agents to achieve a goal.

An explainer agent may be provided to analyze data and provide results of the analysis to another software agent or to a human. The explainer can be configured to provide recommended actions.

A simulator agent can be provided and configured to access a model. The simulator agent may be configured to interact with a history matching agent.

Another embodiment provides a non-transitory computer readable medium including code and data structures that include a personal agent configured to represent a user, an explainer configured to format data and results, a workflow agent configured to obtain data and results needed to achieve a goal for a user and a sensor agent configured to obtain physical or market data for use by other agents.

The non-transitory computer readable may include a data store used to hold data for a facility. The data store may include best practices for operating an asset. The non-transitory computer readable medium may include a simulator or a model.

### DESCRIPTION OF THE DRAWINGS

The advantages of the present techniques are better understood by referring to the following detailed description and the attached drawings, in which:

FIG. 1 is a schematic diagram 100 of a number of hydrocarbon assets that may be controlled in accordance with an embodiment;

FIGS. 2A, 2B, and 2C are block diagrams of a hydrocarbon asset-management system 200 that may be used for information transfer and control during the harvesting, processing, transportation, and use of hydrocarbons, in accordance with an embodiment;

FIG. 3 is a block diagram of an agent, in accordance with an embodiment;

FIG. 4 is a drawing of a community of agents in a functional hierarchy, in accordance with an embodiment;

FIG. 5 is schematic diagram of the interaction of asset-management team members with each other through the personal agents, in accordance with an embodiment;

FIG. 6 is an example of a dependent workflow with multiple interacting autonomous agents, in accordance with an embodiment;

FIG. 7 is a block diagram of activities and work processes that may be performed by various agents in the system, in accordance with various embodiments;

FIG. 8 is a process flow diagram of a method that may be used by an agent, in accordance with an embodiment; and

FIG. 9 is a block diagram of a non-transitory computer readable medium, in accordance with an embodiment.

### DETAILED DESCRIPTION

In the following detailed description section, the specific embodiments of the present techniques are described in connection with embodiments. However, to the extent that the following description is specific to a particular embodiment or a particular use of the present techniques, this is intended to be for exemplary purposes only and simply provides a description of the embodiments. Accordingly, the present techniques are not limited to the specific embodiments described below, but rather, such techniques include all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Coal” is a solid hydrocarbon, including, but not limited to, lignite, sub-bituminous, bituminous, anthracite, peat, and the like. The coal may be of any grade or rank.

“Coalbed methane” (CBM) is a natural gas that is adsorbed onto the surface of coal. CBM may be substantially comprised of methane, but may also include ethane, propane, and other hydrocarbons. Further, CBM may include some amount of other gases, such as carbon dioxide (CO₂) and nitrogen (N₂).

A “compressor” is a machine that increases the pressure of a gas by the application of work (compression). Accordingly, a low pressure gas (for example, 5 psig) may be compressed into a high-pressure gas (for example, 1000 psig) for transmission through a pipeline, injection into a well, or other processes.

The terms “Crude oil” or “hydrocarbon oil” denote a carbonaceous liquid that is harvested from a reservoir. Crude oil has a wide boiling ranges and sulfur content in different fractions.

“Exemplary” is used exclusively herein to mean “serving as an example, instance, or illustration.” Any embodiment described herein as exemplary is not to be construed as preferred or advantageous over other embodiments.

A “facility” is tangible piece of physical equipment, or group of equipment units, through which hydrocarbon fluids are either produced from a reservoir or injected into a reservoir. In its broadest sense, the term facility is applied to any equipment that may be present along the flow path between a reservoir and its delivery outlets, which are the locations at which hydrocarbon fluids either leave the model (produced fluids) or enter the model (injected fluids). Facilities may comprise production wells, injection wells, well tubulars, wellhead equipment, gathering lines, manifolds, pumps, compressors, separators, surface flow lines, and delivery outlets. In some instances, the term “surface facility” is used to distinguish those facilities other than wells.

“Formation” refers to a body of rock or other subsurface solids that is sufficiently distinctive and continuous that it can be mapped, for example, by seismic techniques. A formation can be a body of rock of predominantly one type or a combination of types. A formation can contain one or more hydrocarbon-bearing zones. Note that the terms formation, hydrocarbon reservoir, and interval may be used interchangeably, but will generally be used to denote progressively smaller subsurface regions, zones, or volumes. More specifically, a formation will generally be the largest subsurface region, a hydrocarbon reservoir will generally be a region within the formation and will generally be a hydrocarbon-bearing zone (a formation, reservoir, or interval having oil, gas, heavy oil, and any combination thereof), and an interval will generally refer to a sub-region or portion of a reservoir. A hydrocarbon-bearing zone can be separated from other hydrocarbon-bearing zones by zones of lower permeability such as mudstones, shales, or shale-like (highly compacted) sands. In one or more embodiments, a hydrocarbon-bearing zone includes heavy oil in addition to sand, clay, or other porous solids.

“Hydrocarbon production” refers to any activity associated with extracting hydrocarbons from a well or other opening. Hydrocarbon production normally refers to any activity conducted in or on the well after the well is completed. Accordingly, hydrocarbon production or extraction includes not only primary hydrocarbon extraction but also secondary and tertiary production techniques, such as injection of gas or liquid for increasing drive pressure, mobilizing the hydrocarbon or treating by, for example chemicals or hydraulic fracturing the wellbore to promote increased flow, well servicing, well logging, and other well and wellbore treatments.

“Hydrocarbons” are generally defined as molecules formed primarily of carbon and hydrogen atoms such as oil and natural gas. Hydrocarbons may also include other elements, such as, but not limited to, halogens, metallic elements, nitrogen, oxygen, and/or sulfur. Hydrocarbons may be produced from hydrocarbon reservoirs through wells penetrating a hydrocarbon containing formation. Hydrocarbons derived from a hydrocarbon reservoir may include, but are not limited to, kerogen, bitumen, pyrobitumen, asphaltenes, oils, natural gas, or combinations thereof. Hydrocarbons may be located within or adjacent to mineral matrices within the earth. Matrices may include, but are not limited to, sedimentary rock, sands, silicilytes, carbonates, diatomites, and other porous media.

As used herein, “material properties” represents any number of physical constants that reflect the behavior of a rock. Such material properties may include, for example, Young's modulus (E), Poisson's Ratio (ν), tensile strength, compressive strength, shear strength, creep behavior, and other properties. The material properties may be measured by any combinations of tests, including, among others, a “Standard Test Method for Unconfined Compressive Strength of Intact Rock Core Specimens,” ASTM D 2938-95; a “Standard Test Method for Splitting Tensile Strength of Intact Rock Core Specimens [Brazilian Method],” ASTM D 3967-95a Reapproved 1992; a “Standard Test Method for Determination of the Point Load Strength Index of Rock,” ASTM D 5731-95; “Standard Practices for Preparing Rock Core Specimens and Determining Dimensional and Shape Tolerances,” ASTM D 4435-01; “Standard Test Method for Elastic Moduli of Intact Rock Core Specimens in Uniaxial Compression,” ASTM D 3148-02; “Standard Test Method for Triaxial Compressive Strength of Undrained Rock Core Specimens Without Pore Pressure Measurements,” ASTM D 2664-04; “Standard Test Method for Creep of Cylindrical Soft Rock Specimens in Uniaxial Compressions,” ASTM D 4405-84, Reapproved 1989; “Standard Test Method for Performing Laboratory Direct Shear Strength Tests of Rock Specimens Under Constant Normal Stress,” ASTM D 5607-95; “Method of Test for Direct Shear Strength of Rock Core Specimen,” U.S. Military Rock Testing Handbook, RTH-203-80, available at “http://www.wes.army.mil/SL/MTC/handbook/RT/RTH/203-80.pdf” (last accessed on Jun. 25, 2010); and “Standard Method of Test for Multistage Triaxial Strength of Undrained Rock Core Specimens Without Pore Pressure Measurements,” U.S. Military Rock Testing Handbook, available at http://www.wes.army.mil/SL/MTC/handbook/RT/RTH/204-80.pdf” (last accessed on Jun. 25, 2010). One of ordinary skill will recognize that other methods of testing rock specimens may be used to determine the physical constants used herein.

“Natural gas” refers to various compositions of raw or treated hydrocarbon gases. Raw natural gas is primarily comprised of light hydrocarbons such as methane, ethane, propane, butanes, pentanes, hexanes and impurities like benzene, but may also contain small amounts of non-hydrocarbon impurities, such as nitrogen, hydrogen sulfide, carbon dioxide, and traces of helium, carbonyl sulfide, various mercaptans, or water. Treated natural gas is primarily comprised of methane and ethane, but may also contain small percentages of heavier hydrocarbons, such as propane, butanes, and pentanes, as well as small percentages of nitrogen and carbon dioxide.

“Pressure” refers to a force acting on a unit area. Pressure is usually shown as pounds per square inch (psi). “Atmospheric pressure” refers to the local pressure of the air. Local atmospheric pressure is assumed to be 14.7 psia, the standard atmospheric pressure at sea level. “Absolute pressure” (psia) refers to the sum of the atmospheric pressure plus the gauge pressure (psig). “Gauge pressure” (psig) refers to the pressure measured by a gauge, which indicates only the pressure exceeding the local atmospheric pressure (a gauge pressure of 0 psig corresponds to an absolute pressure of 14.7 psia).

As previously mentioned, a “reservoir” or “hydrocarbon reservoir” is defined as a pay zone (for example, hydrocarbon-producing zones) that includes sandstone, limestone, chalk, coal, and some types of shale. Pay zones can vary in thickness from less than one foot (0.3048 m) to hundreds of feet (hundreds of m). The permeability of the reservoir formation provides the potential for production.

“Reservoir properties” and “Reservoir property values” are defined as quantities representing physical attributes of rocks containing reservoir fluids. The term “reservoir properties” as used in this application includes both measurable and descriptive attributes. Examples of measurable reservoir property values include impedance to P-waves, impedance to S-waves, porosity, permeability, water saturation, and fracture density. Examples of descriptive reservoir property values include facies, lithology (for example, sandstone or carbonate), and environment-of-deposition (EOD). Reservoir properties may be populated into a reservoir framework of computational cells to generate a reservoir model.

A “rock physics model” relates petrophysical and production-related properties of a rock formation (or its constituents) to the bulk elastic properties of the rock formation. Examples of petrophysical and production-related properties may include, but are not limited to, porosity, pore geometry, pore connectivity volume of shale or clay, estimated overburden stress or related data, pore pressure, fluid type and content, clay content, mineralogy, temperature, and anisotropy and examples of bulk elastic properties may include, but are not limited to, P-impedance and S-impedance. A rock physics model may provide values that may be used as a velocity model for a seismic survey.

### Overview

For the reasons discussed above, there is a need for information-technology asset-management systems to assist with managing asset-management team work processes through an automation paradigm empowered by human knowledge. Such systems aim to improve the way data is gathered, managed, distributed, analyzed and presented to asset-management team members in such a way that achieve their individual goals without compromising the asset level goals, for example, set by the company's key performance indicators (KPIs).

Exemplary embodiments of the present techniques provide methods and systems for enhancing control of assets. Such assets may include reservoirs, production wells, injection wells, surface processing facilities, pipelines, refineries, chemical plants, and customer facilities, among many others. Automating the work processes of such a complex system may enhance the management of hydrocarbon assets.

In an embodiment, a knowledge-based automation of distributed and interconnected workflows for an asset management team may be used to improve data collection and analysis for decision makers, from simply providing information up to setting up a control input and requesting permission to proceed. In some embodiments, the permission to proceed may be assumed, and a reporting function informs relevant personnel of the actions taken. The actions may be performed by an interactive community of software agents. As used herein, “software agents” and “agents” are synonymous.

The agents may be autonomous, e.g., performing the majority of their problem solving tasks without the direct intervention of humans or other agents. Further, the agents have control over their own actions and their own internal state. The agents may also be proactive, taking the initiative where appropriate.

The agents may have some social ability, such as the ability to have a cogent communication with other agents or humans, when they deem appropriate, in order to complete their problem solving, and to help other agents with their activities. This requires that agents have a means by which they can communicate their requirements to others and an internal mechanism for deciding what and when social interactions are appropriate, both in terms of generating requests and judging incoming requests. Relevant to the interactions, the agents may perceive their environment and respond in a timely fashion to changes in the environment.

In some embodiments, agents can provide an asset-management team member with a relevant system status at an appropriate time in addition to providing a proposed set of optimal actions in response to the changing nature of the asset. The agents may allow the asset-management team member to request and obtain information management services from other asset-management team members or from outside sources, such as market conditions, and proactively identify and deliver timely, relevant information, even when not directly requested. Agents may inform the asset-management team member of changes which have been made elsewhere in the asset or other work processes process which may impact the current decision/action context. Further, the agents may identify individuals, within the asset-management team or others within the company, who may be either interested or needed in both the process and the outcome/results of the decision-making activity.

The agents may be simple, for example, obtaining a single value from a sensor system, and presenting the value to a person, another agent, storing the value into a database or other data store, or any combination thereof. In some embodiments, the agents may include complex agents, for example, agents termed “explainer agents” may be used to analyze results, provide recommendations concerning actions, run simulations to determine specific actions, and the like. Other complex agents that may be used include “personal agents” that may be used by team members as proxies in the community of agents. For example, a personal agent may be used by a reservoir engineer to obtain pressure readings for wells in a certain reservoir, to run simulations of the reservoir, and to recommend actions concerning the reservoir. It will be clear that team members many take many other actions through the agents.

The personal agents may also receive unsolicited communications from other agents, such as explainers, sensors, and the like, which may be passed on to the associated team member. Such communications may be used, for example, to inform a reservoir engineer that a well is functionally “shut-in,” or to inform a geologist that simulation results are finished, among many other functions.

Further, complex agents may also include “workflow agents,” which, as used herein, are agents that may be activated or instantiated to achieve a specific goal. For example, a workflow agent may be activated or instantiated, for example, in response to a request from a group of personal agents representing an asset-management team, to determine what steps may be taken to increase production from a field. The workflow agent may then access other agents, such as data storage agents, simulation agents, and personal agents representing experts not affiliated with the team, to develop recommendations for changes to the field that may increase the production. If a workflow agent is unable to fulfill a goal, it may communicate with a personal agent in order to engage human intervention.

Thus, to manage an asset, a collection of asset goals may be entered by the asset-management team, for example, through their respective personal agents. The workflow agents may then collaborate, interact, or even compete to achieve the goals. The multi-agent system will operate in a virtual environment that may include additional agents or other entities that operate outside the boundaries of the system being described.

### Hydrocarbon Assets and Command and Control Systems

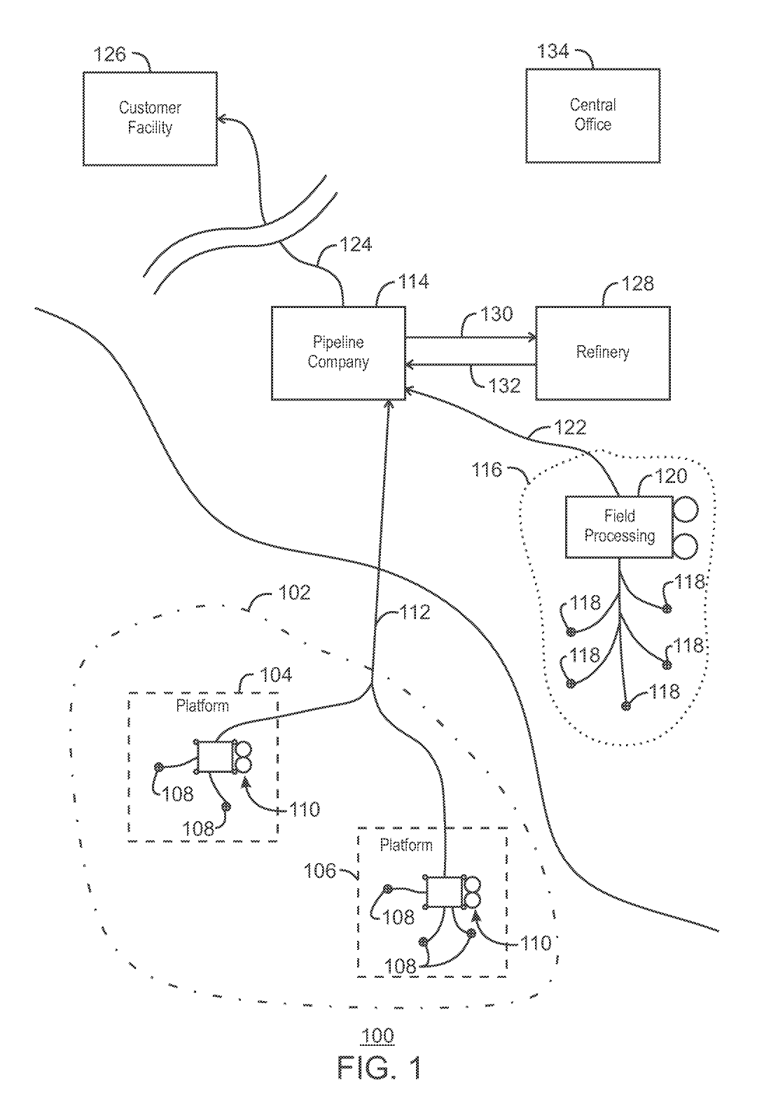

FIG. 1 is a schematic diagram 100 of a number of hydrocarbon assets that may be controlled in accordance with an embodiment. In an embodiment, a multi-agent system can be used to support asset-management teams' work processes to optimize management and utilization of the hydrocarbon assets. The multi-agent system may imbed best practices and human expertise and knowledge within distributed systems of the agents to provide decision support.

In embodiments, a hydrocarbon asset-management system may include a team of technical professionals managing the asset, data collected by sensors, a set of analytical procedures, such as quality control, data cleansing, simulation and prediction, and optimization, among others, and related software tools. The hydrocarbon asset-management system may also include human knowledge and expertise that may reside within the asset-management team or in other parts of the company. Key performance indicators (KPI's) may be generated to set the goals and targets for individual assets as well as collections of assets in a potentially hierarchical manner.

As shown in the schematic diagram 100, an energy company may include numerous facilities for finding reservoirs, producing hydrocarbons, transporting hydrocarbons, forming secondary products from the hydrocarbons, and distributing products to customers, including, for example, distribution companies and end users. The schematic diagram 100 illustrates the complexity that may be associated with managing the facilities and resources so as to meet certain organization-wide goals, such as maximizing profits, or maximizing total production from various assets, among others.

For example, an offshore reservoir 102 can be serviced by a first production platform 104 and a second production platform 106. Each of the production platforms 104 and 106 may access a number of sub-sea wells 108 to harvest hydrocarbons from the offshore reservoir 102. The sub-sea wells 108 may include both injection and production wells. To prepare the hydrocarbons for shipping, the production platforms 104 and 106 may have on-board processing systems 110, for example, for separating oil, gas, and water streams prior to transporting a hydrocarbon stream to shore through a sub-sea pipeline 112. The sub-sea pipeline 112 may be one of a number of pipelines managed by a pipeline company 114. The pipeline company 114 may be owned by the energy company or may be a separate entity. In either case, the pipeline company 114 may participate in the system for the management of the assets, for example, using autonomous agents to recommend adjustments in flow rates and product mixes.

As an example of another set of assets, an on shore reservoir 116 may be accessed by a number of wells 118, which may include both injection and production wells. The hydrocarbon from the wells 118 may be processed for transportation at a field processing facility 120, for example, to separate hydrocarbons and water. The hydrocarbons may be shipped to other facilities by a pipeline 122, which may also be managed by the pipeline company 114. The hydrocarbons may be directly sent to market, for example, through a product pipeline 124 feeding a customer facility 126. Depending on the desired products, the hydrocarbons may first be sent to a refinery 128 through a processing pipeline 130. Refined products may then be sent on to customer, such as a customer facility 126, through a refined products pipeline 132 feeding the product pipeline 124.

As is clear to those of skill in the art, the schematic diagram 100 is simplified for explanation. An actual energy company may have hundreds or even thousands of facilities around the world. Further, embodiments are not limited to the arrangements shown, but may include any number of other resources, such as coal beds, coal bed methane, oil sands and other bitumen deposits, or geothermal energy sources. Transportation venues may include not only pipelines, but also railcars, tankers, and numerous other venues. Accordingly, managing the assets to meet business goals may be an extraordinarily complex task. In an embodiment, this task may be improved by the use of autonomous agents that are programmed with goals, data, and plans, among others.

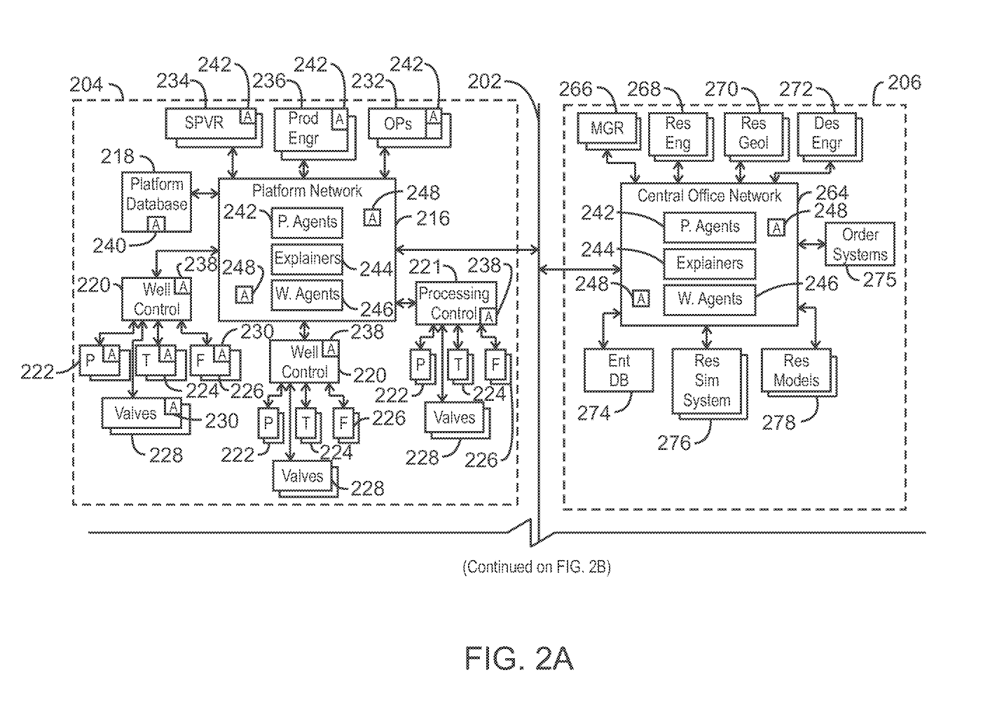

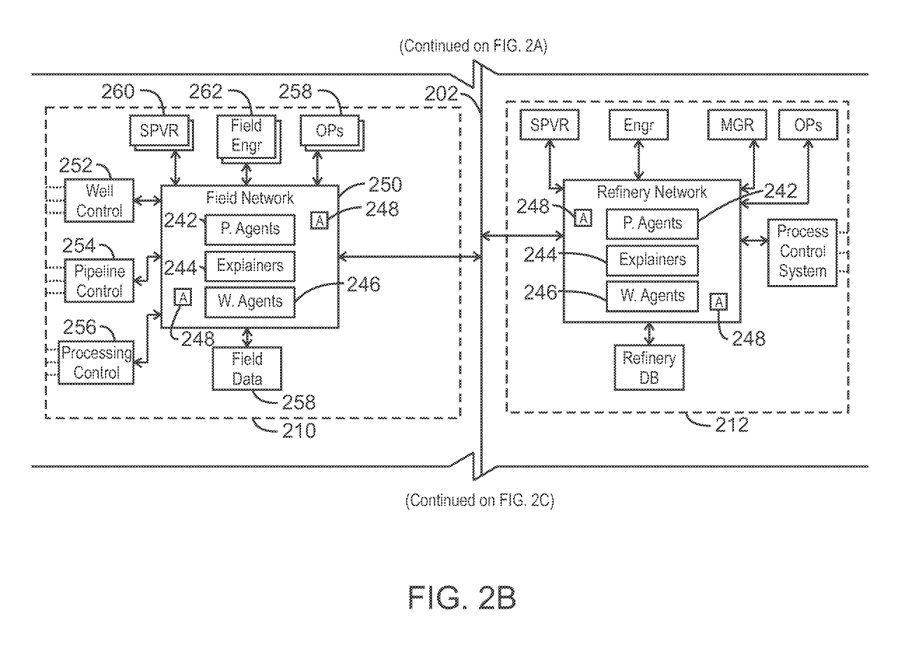

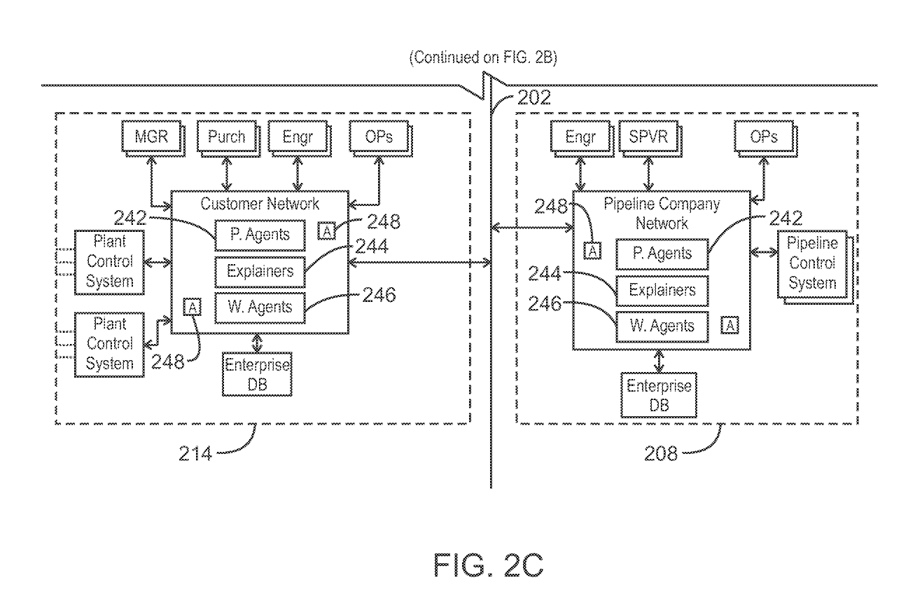

Decisions concerning the management of the assets make take place both at the field facilities and at one or more central offices. For example, a central office 134 may manage the processes, making decisions concerning, for example, water injection rates into the reservoirs 102 and 116, production rates from the reservoirs 102 and 116, well types, product mixes from the refinery 128, and the like. To facilitate this control, the central office 134 may be coupled to the remote facilities by a network. This is discussed further with respect to FIGS. 2A, 2B, and 2C.

FIGS. 2A, 2B, and 2C are block diagrams of a hydrocarbon asset-management system 200 that may be used for information transfer and control during the harvesting, processing, transportation, and use of hydrocarbons, in accordance with an embodiment. In the hydrocarbon asset-management system 200, a central backbone 202 may couple systems for the various facilities. The central backbone 202 may be a wide-area network (WAN), a local area network (LAN), or the Internet, for example, using a virtual-private network (VPN).

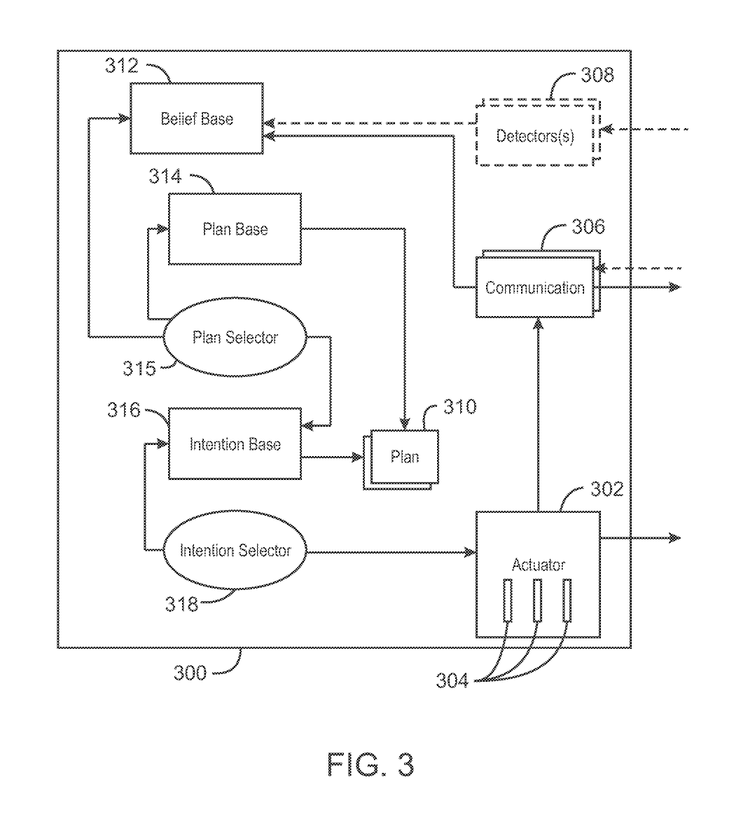

A platform network 204, such as a computer network controlling a platform 104 or 106 (FIG. 1), may be connected to the backbone 202 for communications with other facilities, such as a central office 206 or a pipeline company 208 (FIG. 3C). Other facilities, as discussed with respect to FIG. 1, may also be connected to the backbone 202, including, for example, a field network 210, a refinery network 212 as shown in FIG. 2B, or a customer network 214, as shown in FIG. 2C.

Each of the facilities may include a sub-network, including, for example, a number of servers coupled to other systems providing data stores and control computers. For example, the platform network 204 may include one or more servers 216 coupled to a database system 218. One or more well control systems 220 and process control units 221 may be included in the platform network 204. The well control systems 220 or process control units 221 may include any combinations of distributed control systems (DCSs) or programmable logic controllers (PLCs), among others.

Each of the well control systems 220 or process control units 221 may be coupled to sensors, such as pressure sensors 222, temperature sensors 224, flow sensors 226, and any number of other sensors. The well control systems 220 and process control units 221 may also operate numerous valves 228 for controlling the flow of fluids. Numerous other devices may also be coupled to the systems 220 and 221 to provide control over fluid flows and systems, including, for example, pumps, motors, or any number of other devices. Depending on the level of distribution of intelligence in the platform network 204, the sensors, valves, and actuators may be any combination of “smart” systems or “dumb” systems. For example, in various embodiments, any or all the sensors 222, 224, or 226, valves 228, or other actuators, may be compatible with a distributed intelligence control system, such as the FIELD BUS standard, and, thus, have a local controller capable of providing some intelligence to the operations. The local controller may allow operation of simple agents 230. In some embodiments, some or all of the sensors 222, 224, or 226, valves 228, or other actuators, may be dumb units that are totally controlled by the well control system 220 or process control system 221.

Users may interface with the servers 216 of the platform network 204 through other systems. For example, an operations control system 232 may allow operators to monitor and control operations of the wells and processing units. Operations may be monitored by various levels of supervisors, managers, or superintendents, for example, from one or more supervisory systems 234. Operations may also be monitored by production engineers, such as from one or more production engineering workstations 236.

In addition to the simple agents 230 that may be operating in smart sensor, valves, or actuators, other agents may operate at any or all levels in the system. For example, in some embodiments, process control agents 238 may operate in the well control systems 220 and processing control system 221. Data agents 240 may store data into, or obtain data from, the platform database 220. Personal agents 242 may be operating on workstations 232, 234, and 236, to represent users in the community of agents. In embodiments, any or all of these agents may be operational on the servers 216 of the platform network 204. For example, in an embodiment, the personal agents 242 may be operational on the servers 216 to make them accessible from any convenient system a user is accessing. Further, complex agents, such as explainers 244, or workflow agents 246 may be instantiated on the servers 216 of the platform network 204 to provide direct access to the communications and other resources of the platform network 204. Further, any number of other agents 248 may be created on the servers 216 in addition to or instead of other systems on the platform network 204. In the explanations to follow, the agents are illustrated on the central servers of each facility merely for simplicity. However, it will be clear that any of the agents described may be instantiated on any of the other systems in the networks in addition to, or instead of, the central servers.

One or more field networks 210 (FIG. 2B) may be connected to the backbone 202 of the hydrocarbon asset-management system 200. As for the platform network 204, the field network 210 may have one or more process control systems connect to one or more servers 250 in the field network 210. The process control units may include, for example, well control systems 252, pipeline control systems 254, or processing control systems 256, among others. The process control units 252, 254, and 256 will generally be connected to sensors and actuators to control wells and processes, as indicated by the dotted lines. A field database 258 may be used to store data collected from the field, such as readings from sensors and actuators (indicated by dotted line) controlled from the process control systems 252, 254, and 256. The field network 210 may have local control systems that allow users to access the field network servers 250, such as operations systems 258 to control the process control systems 252, 254, and 256. Further, one or more supervisor systems 260 may be used to oversee operations. Operations may be monitored, for example, by field engineers, from one or more engineering workstations 262. Any or all of the systems of the field network 210 may have operating agents, such as personal agents 242, explainers 244, workflow agents 246, or other simple or complex agents 248, in accordance with various embodiments.

A central office network 206 (FIG. 2A) may be coupled to the backbone 202 to provide a central command and control function. For example, a number of asset-management team members may be located at the central office, while other asset-management team members can be located at the remote facilities. The central office network 206 may have a cluster of servers 264 that may be accessed from management systems 266, as well as from systems for various experts, including reservoir engineering workstations 268, reservoir geology workstations 270, design engineering workstations 272, and many others. The central office network 206 may also include other resources that may be used by various agents to provide or obtain data. For example, the central office network 206 may have an enterprise database 274 used to store data for the energy company, including such data as production amounts, orders, purchased amounts, revenue from production, and the like. Data may be obtained by the enterprise database 274, from asset-management team members, and directly from various facilities coupled to the backbone 202, such as the platform networks 204, the field network 206, the refinery network 212, the pipeline company 208, or various customer networks 214. Furthermore, the enterprise database 274 may contain a knowledgebase that includes domain knowledge, asset history, or other relevant information stored in traditional database schemas or non-traditional formats such as a semantic web or rules of an inference engine. In an embodiment, an ordering system 275 may have agents 248 that communicate with agents 248 in a customer network 214 (FIG. 2C) to ensure that sufficient supplies of various hydrocarbons are provided to the customer when needed. Further, the central office network 206 may have agents 248 that access simulators 276 to model reservoirs. These simulator agents may generate or access reservoir models 278 and refer to the knowledge base in order to provide explanations to humans via the personal assistant agents.

Various agents, such as the workflow agents 246 may call on other agents 248 to generate recommendations for meeting various goals. As an example, a production engineer on an offshore platform may use a production engineering workstation 236 to access a personal agent 242 to obtain recommendations for dealing with a production anomaly reported to the personal agent 242 by a well control system 220. The personal agent 242 may generate a workflow agent 246 that is given the goal of obtaining the recommendations. The workflow agent 246 can obtain data from agents 248 on the well control system 220, as well as historical data for the well from agents 248 associated with the platform database 218. The workflow agent 248 may then access an explainer 244, which can communicate with a simulator agent in the central office network 206. The simulator agent may use a reservoir simulator 276 to determine possible reasons for the anomaly. Further, the workflow agent 246 may also inform personal agents 242 for other asset-management team members of the anomaly, for example, displaying the report on a reservoir engineering workstation 268, a reservoir geology workstation 270, and the like. The workflow agent 246 may then provide the results to the personal agent 242 for storage and display on a production engineering workstation 236.

In some embodiments, agents, including workflow agents, may be configured to compete with each other for resources. Such resources may include computer time, analysis tools, active memory, and the like. The priority given to an agent may be based on the importance of the action being pursued, the amount of memory the agent needs, the amount of computing power the agent uses, and the like.

Other agents 248 may also take appropriate actions with the results and information from the workflow agent 246. For example, the data from the well controller 220 may be used by a history matching agent to update the reservoir models 278 to enhance future predictions of the reservoir performance. Further, if an anomaly has caused a drop in production from the platform, a business agent may communicate with other agents to compensate for the decreased production, for example, by submitting requests for production increases to personal agents for members of other asset-management teams. This may include submitting a request to a personal agent 242 for a production supervisor at the field network 210 (FIG. 2B). It will be clear that the system is not limited to performing in this fashion. For example, the personal agent 242 may automatically activate the workflow agent 246 when the agent 238 for the well control system 220 reports the anomaly. Further, the personal agent 242 may directly access the data from the well control system 220, contact the explainer 244, and the like, without creating a separate workflow agent 246.

As this example indicates, the hydrocarbon asset-management system 200 may be modeled as a multi-agent system. The multi-agent system may provide just-in-time data analysis, asset state, and proposed decisions to achieve asset goals while responding in a timely fashion to changing and dynamic conditions within the reservoirs, physical units, and market.

To effectively control the agents, the hydrocarbon asset-management system 200 may include resources, workflows, goals, and rules. Resources include the actual objects within the system such as reservoirs, wells, pipelines, analysis tools, databases, asset-management team members, for example, as discussed with respect to FIG. 1.

Workflows, or work processes, include the activities performed by asset-management team members during which the asset state may change. Workflows are governed by rules and they describe how work should be done to achieve system goals. The goals include the asset-management systems' desired state or outcomes. The goals may be usually described as a set of key performance indicators (KPIs).

The rules include statements that define or constrain some aspects of the asset system components, and represent business knowledge. They govern how the management system should be run, for example, a rule may indicate how a workflow should be executed, or how a resource needs to be managed. Rules can contain external factors, such as contractual or environmental regulations and production quotas. Rules are defined to achieve business goals in the “best” way within the system internal and external constraints and using the system's (or company's) knowledge. The rules become a part of the constraint system or bounds used to control the activity of the agents. Further, rules may be stored in global knowledge bases, which may provide a best practices store.

As indicated above, the hydrocarbon asset-management system 200 may have other systems coupled to the backbone 202, such as a refinery network 212 (FIG. 2B), a pipeline company 208 (FIG. 2C), or a customer facility 214 (FIG. 2C). Each of these facilities may have similar components to those discussed above. Further, agents 242, 244, 246, and 248, among others, may be used in these systems to communicate with other agents on the system.

Compatible agents 248 may be present in facilities that are outside of the energy company, such as the customer facility 214 or the pipeline company 208, and others. In some embodiments, agents 248 present within the energy company may be designed with detectors to obtain and translate information and data from the outside systems, without the use of agents on the outside systems.

### Agents

FIG. 3 is a block diagram of an agent 300, in accordance with an embodiment. In various embodiments, agents represent both the system's resources and workflows. The systems' rules, or knowledge, may be distributed naturally among the agents in the system wherein a significant part of the system knowledge is embedded within the workflow agents, analysis tools agents, and personal agents.

Generally, an agent 300 may be defined as a coded data structure running on a computer system, which can be capable of flexible, autonomous, problem-solving action, situated in dynamic, open, uncertain, and typically multi-agent environments. Each agent 300 may represent a single unit or collection of units as necessary to support the workflows. In an embodiment, an agent 300 may include an actuator 302 with multiple threads 304, or subprograms, running in a parallel fashion.

Because of the heterogeneity of the system's agents, autonomy and cognitive capabilities, different design architectures may be used in building the proposed system's agents. For example, a reactive agent architecture may be used to model input sources such as sensors while deliberative agent architecture may be used to model controllers such as valves. A reactive agent is an agent that monitors a condition and reacts based on its perception of a need. A deliberative agent, on the other hand, proactively modifies the external environment based on a need, for example, deduced through a deliberation such as an optimization model. Decision-maker electronic personal assistants may be modeled using a hybrid architecture.

Analysis and simulation tools may be modeled to include mobile agents to accommodate data security and data band-width restrictions. Mobile agents refer to an agent's ability to migrate its execution to different computing platforms. This may be useful, for example, to avoid the need to move large amounts of data between computers merely to allow an analysis to be performed locally where the data resides. The migration may improve network and computational performance. Both reservoirs and markets can be modeled as uncertain environments. Although markets are rarely modeled as part of asset production systems, the recent focus on gas fields and their more fluid markets makes their inclusion in the system useful.

Workflows may be represented as goal oriented agents or may be inherently incorporated through the interactions of a collection of agents. Coordination between workflows or workflow agents can be governed by a set of protocols set by asset-management team members.

Further, the hydrocarbon system resources themselves may also be represented as agents in the invention. For example, members of the asset-management team and physical entities, such as wells, sensors, facilities, and markets may all be represented by agents. The degree of autonomy and intelligence of an agent can vary depending on its role and user's goal. Agents representing human assistants, e.g., personal agent, or workflow agents can be embedded with a high degree of autonomy and cognitive capability. These agents may be capable of creating a number of simultaneous threads 304 when needed to execute rules in interpretation and decision-making. Agents representing physical entities, such as sensors, wells, facilities, and the like, may have limited autonomy and low cognitive capability, for example, having only a few threads 304 operational. Such entities may coordinate with more advanced supervising agents, such as personal agents or workflow agents.

In a test of an embodiment, agents 300 were developed using a Foundation for Intelligent Physical Agents (FIPA)-compliant agent software system to implement a prototype of an example of the design outlined in the preceding sections. The system was implemented in C#/C++ using Visual Studio from MICROSOFT®. Although aspects of the design are described below, it will be clear that the agents 300 are not limited to these elements or this design, but may be modified to suit the application of the agent.

For use in the prototype, a class library of Agent components was created to aid a developer in creating an Agent infrastructure. Developers can instantiate an agent object which would automatically compose the internal multi-threaded components of the actuator 302 and start a built-in communications layer 306.

As noted, the agent 300 that may be created from the library is a multi-threaded object. Some of the internal components can be operating their own thread 304, and may be constantly doing some work, such as detectors 308, which are looking for input. Other components are activated for a temporary amount of time on a thread 304 from the agent's 300 thread pool, such as plans 310. Additionally, there are several other components used as information stores.

To create an agent 300, the developer must first create a detector 308 for the agent 300. A detector 308 is used by an agent 300 to gather information about its environment or the subject of its responsibility. A detector 308 can obtain information from any source including, but not limited to, text files, databases, web services, direct hardware connections, and the like. An agent 300 may have multiple detectors 308 to obtain information from multiple sources and of multiple types. The abstract sensor class that the detector 308 extends does not limit how the detector 308 gets its data. However, it does facilitate the agent 300 being able to activate the detectors 308 and use the information that it senses. The detector 308 senses the information in a continuous loop and stores the information it senses into a BeliefBase 312.

The BeliefBase 312 may be used as the main data store for the agent's knowledge. Any information that the detectors 308 have been developed to sense can be stored in the BeliefBase 312. This information is constantly updated as the detectors 308 receive changes to the data they monitor. The information represents conditions that can be used by the selector components of the agent 308 to determine the actions to perform. In addition, information obtained from communications with other agents 300 through the communications layer 306 may also be stored to the BeliefBase 312.

In addition to creating detectors 308, a developer must also create plans 310 for the agent. A plan 310 includes instructions for the agent 300 to perform. It may also include conditions that need to be met in order for the agent 300 to be started or instantiated. A plan 310 can contain an importance level and a list of other plans that it conflicts with. All this information is used by the selector components of the agent 300 to determine which plans 310 the agent 300 should be performing and when.

A PlanBase 314 is the store of all the plans 310 that the agent 300 has been given. After instantiating the agent object, the developer would then add all the plans 310 that have been created for the agent 300. Alternatively, a detector 308 could be created to monitor an external location for plans 310 that could be performed by an agent 300. In an embodiment, this may be used to dynamically change the performance of an agent 300.

A PlanSelector 315 controls when a plan 310 can be performed by the agent 300. This component constantly checks the conditions on the plans 310 and the BeliefBase 312 to see when a plan 310 can be run. The PlanSelector 315 then takes the plan 310 and puts it in the IntentionBase 316. The PlanSelector 315 does not decide that the plan 310 should be run, but rather that it can be run at that particular time.

The IntentionBase 316 is a queue of all the plans 310 that can be run, for example, listed in the order that their conditions were met. The IntentionBase 316 is used by the IntentionSelector 318 when it decides whether a plan should be run given other current circumstances. When a plan is picked up by the IntentionSelector 318 for a decision on whether to run it or not, it is removed from the IntentionBase 316 entirely until the PlanSelector 315 puts it back. The PlanSelector 315 chooses from the PlanBase 314 those plans which can be run based on triggers, and adds them to the IntentionBase 316, whereas the IntentionSelector 318 chooses from the IntentionBase 316 those plans which should be run based on current conditions.

The IntentionSelector 318 pulls the next available plan 310 from the top of the IntentionBase 316 and makes a decision on whether it should be run or not. This component will check the BeliefBase 312 to see if the run conditions for that plan 310 still exist, and it will check to see if other plans 310 are currently running, for example, in this or other threads 304, that conflict with the new plan 310. In the event that the new plan conflicts with existing plans 310, it will determine which one is more important and send instructions to the actuator 302. For example, the IntentionSelector 318 may send the plan to the actuator 302 to be run, or may send a message to stop a currently running plan 310 before sending on the new plan, or may discard the new plan altogether.

The Actuator 302 is the component that actually implements the plans. It can receive a plan from the IntentionSelector 318 with instructions to run it. The plan 310 is then spawned off onto a new thread 304 from the thread pool. It can also receive a message to stop a currently running plan 310 before starting a new plan, for example, in case of a conflict. The actuator 302 is not run on a separate thread, but instead only acts when it receives messages from the IntentionSelector 318.

Agents 300 created in the agent library come with a built-in communication layer 306. Communication between agents may be based on the standard proposed by the FIPA. Communication may be performed using XML messages over TCP/IP. To assist in communications, a directory facilitator service was constructed so that agents 300 could identify information about other agents 300. The directory facilitator, which may be an agent, may be especially useful in larger embodiments, for example, when agents are located in multiple facilities. The agents 300 discussed above may be arranged in a hierarchical structure.

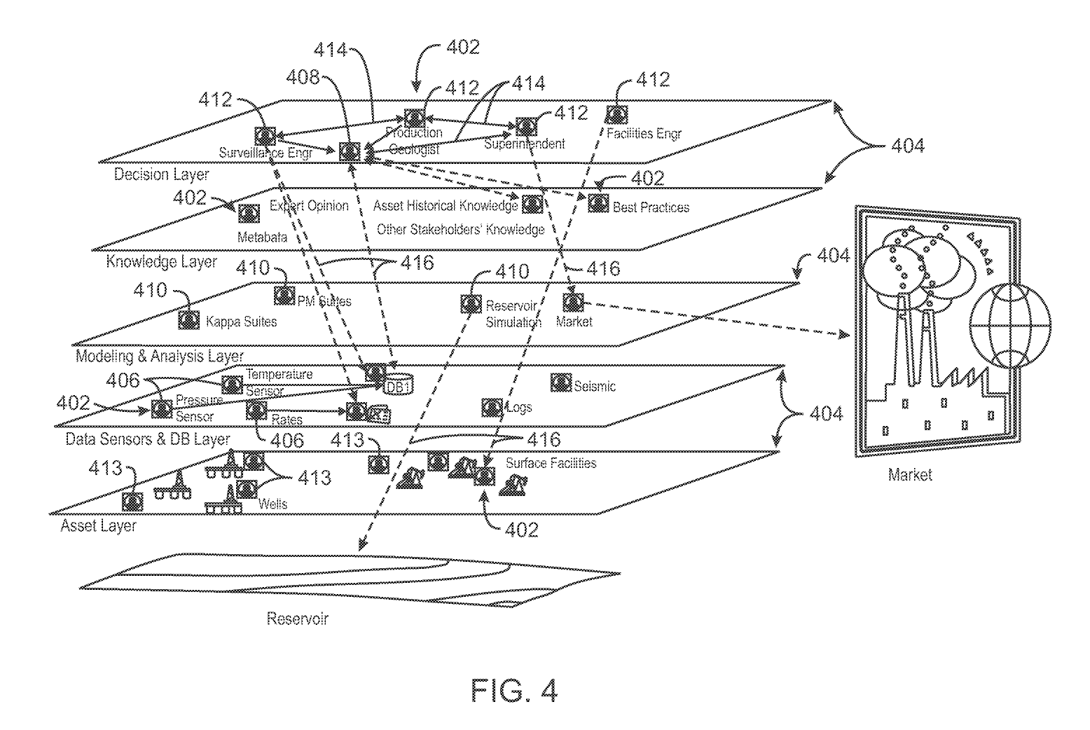

FIG. 4 is a drawing of a community 400 of agents 402 in a functional hierarchy, in accordance with an embodiment. As mentioned, the asset-management system can be is modeled as a society of agents with potentially multiple layers, or communities, in a hierarchy. Each layer 404 has multiple agents representing a specific functionality within the system, e.g., sensing agents 406, workflow agents 408, modeling agents 410, personal agents 412, and agents representing physical systems 413, such as wells and platforms. Agents 402 within a layer may collaborate and coordinate, as indicated by arrows 414, to reach the goals set by the system users. Agents 402 in different layers may also communicate with agents in other layers to request services or knowledge, as indicated by dotted arrows 416. The layers 404 may be decomposed based on knowledge and autonomy of the agents 402 at each layer 404, with more advanced agents 402 generally residing higher in the hierarchy.

Agents 402 may collaborate, coordinate, or compete to provide the decision-maker, represented by personal agents 412, with all the elements that are needed to make flexible and robust decisions. The system may be used in one of two modes. An advisory mode can provide a decision-maker with data analyses, abnormal events, root causes, and a set of proposed corrective actions or suggested opportunities. In a hybrid mode, certain agents, e.g., gas-lift controllers, flow controllers, temperature controllers, and the like, may be used in a closed-loop fashion while the remaining system provides an advisory mechanism to the asset-management team. In all cases expert knowledge is captured through knowledge engineering tools and practices.

### Interactions of Personal Agents

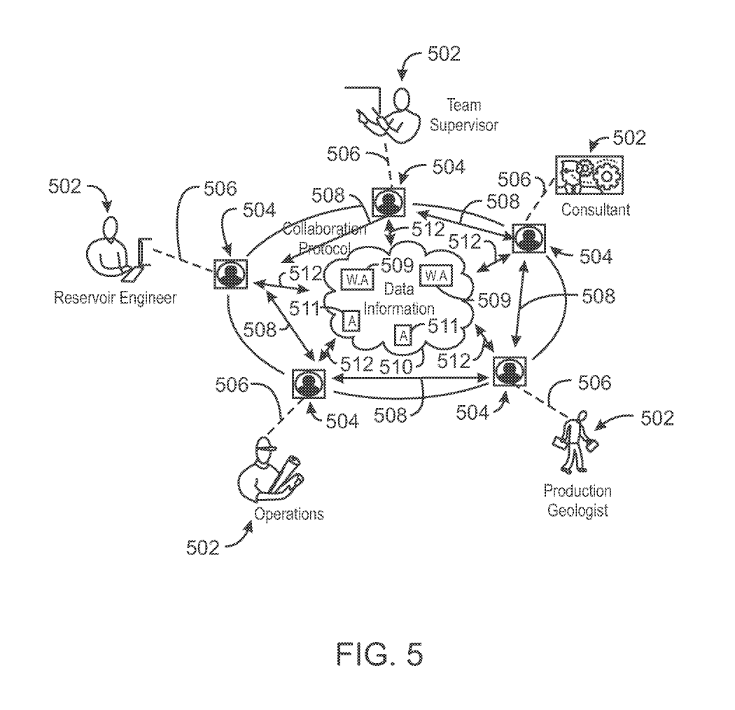

FIG. 5 is schematic diagram 500 of the interaction of asset-management team members 502 with each other through their respective personal agents 504, in accordance with an embodiment. Each of the personal agents 504 can interact with their associated user, as indicated by dotted lines 506, and each of the personal agents 504 may interact with every other personal agent 504 of the asset-management team members 502, as indicated by arrows 508. Such collaboration may result in the creation or activation of other agents, such as workflow agents 509. Further, the personal agents 504 may each interact with a pool 510 of agents 511 that can provide further data and Information, as indicated by another arrow 512. The schematic diagram 500 may illustrate some of the interactions that take place at the decision layer in FIG. 4, while the pool 510 may represent agents at all other layers. The schematic 500 represents one embodiment of the knowledge-level system, it will be clear that any number of other designs and management models may be used.

Personal agents 504 interfacing with and representing asset-management team members 502 may encapsulate the knowledge of their human counterpart either by direct input or, over time, through learning mechanisms. Furthermore, they have access to field and asset knowledge, such as through interaction with other asset-management team agents and databases, and corporate knowledge, through interaction with corporate-wide knowledge bases.

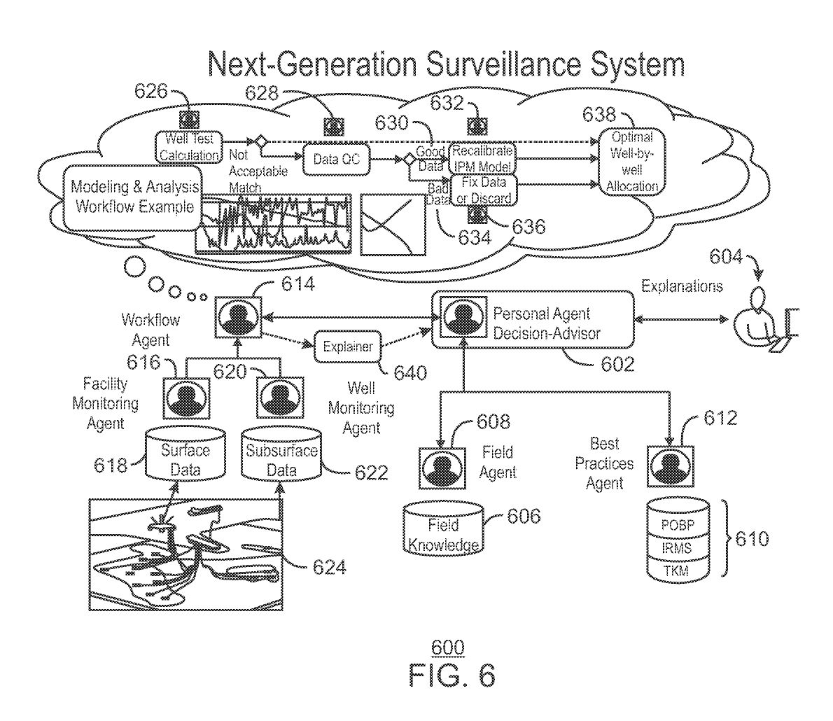

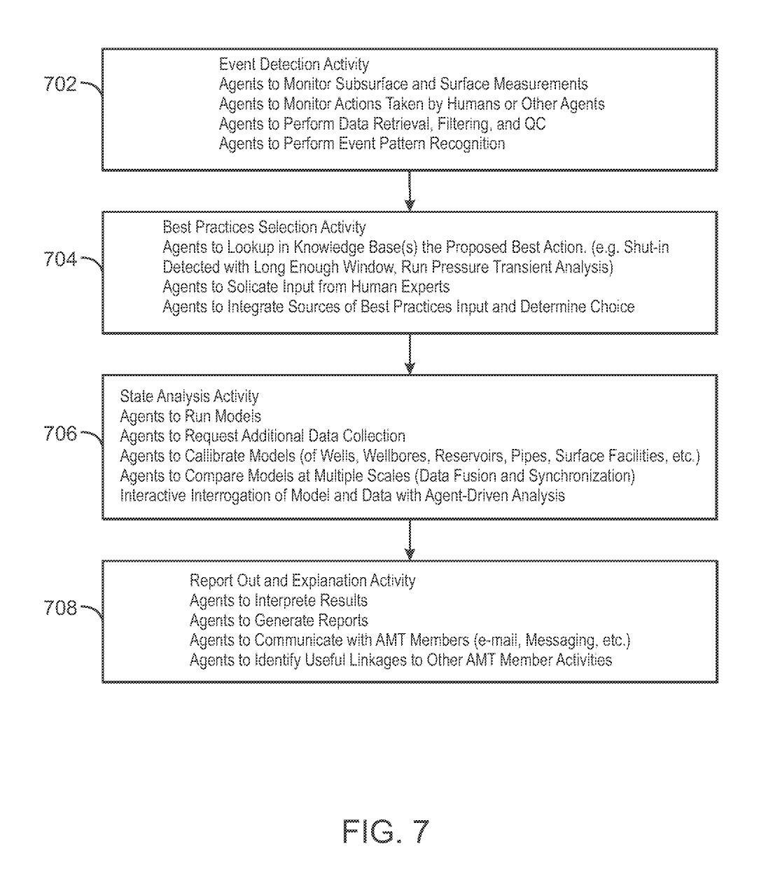

FIG. 6 is an example of a dependent workflow 600 with multiple interacting autonomous agents, in accordance with an embodiment. As shown in FIG. 6, a personal assistant 602 may interact with an asset-management team member 604. The personal assistant 602 may also interact with other agents, for example, obtaining field knowledge 606 from a field agent 608 and best practices 610 from a best practices agent 612. The personal agent 602 may activate a workflow agent 614 to determine the current status of a field and make recommendations for future operations. The workflow agent 614 may call on a number of other agents to obtain data and model the field. For example, the workflow agent 614 may communication with a facility monitoring agent 616 to obtain surface data and production data 618 for the field. A well monitoring agent 620 may provide the workflow agent 614 with subsurface data 622 for a reservoir 624. The workflow agent 614 may also communicate with a number of agents to model the field and analyze the results from the facility monitoring agent 616 and well monitoring agent 620. Such agents may include a well testing agent 626 that provides test calculation data. The calculation data may be presented to a QC agent 628 for review and removal of poor data. Good data 630 may be presented to a history matching agent 632 to recalibrate the model, while bad data 634 may be passed to a data repair agent 636. The data repair agent 636 may fix the data, for example, identifying that the data is in the wrong units and converting the data to the correct units. The data repair agent 636 may determine that the data cannot be repaired and discard the data. The outcome of the modeling and analysis may be an optimal well-by-well allocation plan 638, for example, identifying each well as an injector or producer and recommending a flow rate into or out of the well. This plan may be returned to the workflow agent 614. The workflow agent 614 may then present the plan directly to the personal agent 602 for presentation to the user 604. In an embodiment, the workflow agent 614 may send the results to an explainer agent 640 to generate graphical outputs, recommendations, and future predictions, which may clarify the results. The explainer agent 640 may then work with the personal agent 602 to present the results to the user 604. Further, the explainer agent 640 may contact other agents to determine other results. Any number of agents may participate in the asset management, as discussed with respect to FIG. 7.

FIG. 7 is a block diagram 700 of activities and work processes that may be performed by various agents in the system, in accordance with various embodiments. It will be clear that this is not a comprehensive listing of all agents that may be operational in a system, but merely an example of some of the agents that may function at various levels in the hierarchy. Further, embodiments are not limited to the workflow shown. Any number of interactions between agents is not only allowed by the system, but also provides a more robust control of the system.

In various embodiments, agents may be used to detect events, as shown at block 702. When events are detected, agents may be present to select the best practices or actions for responding to the events, for example, based on historical records or human experts, as shown at block 704. Agents may exist to analyze the state of the system that triggered the event, for example, by running models of the system or by collecting additional data, as shown at block 706. Finally, agents may exist to interpret and present results, as shown at block 708.

### EXAMPLES

Reservoir management processes consist of a combination of common and proprietary analyses that are executed at different times for different types of assets at different frequencies. Manual intervention in most reservoir management processes is a requirement due to the subjective nature of many analyses. In various embodiments, software agents may perform the analysis in place of a human, enabling computer automation of the process. The automation may be open loop, in which a human is given the opportunity to decide what to do next, or closed loop, in which a fully automated process performs without human intervention. Software agents can have this capability, because they can be given a discrete amount of human knowledge that can be encoded in their knowledge base and used to simulate human judgment for very specific tasks.

An example of a reservoir management process is a well optimization. This could take the form of a workflow which goes through a series of checks and analyses whenever a new well test is measured. The workflow may include monitoring the production database for new well tests. When found, the new well test may be validated against a choke correlation. The new well test may be compared to a trend of historical well tests as a second validation. The new well test may also be compared to a well model to determine if the well model is reasonably calibrated or if the well test is bad. If there is a problem with the well model, some action will be recommended, for example, a data evaluation may be performed, which may be followed by a history matching procedure to tune the model.

If the well test is valid, a determination may be made as to whether the productivity index (PI) is reasonable. If the PI is not reasonable, then an action can be recommended. If the PI is reasonable, a determination may be made as to whether the well drawdown is optimal. If the well drawdown is not optimal, then an action can be recommended.

Each of these individual steps, or any combination of them, may be performed manually. However, in various embodiments, one or more steps in the workflow may be automated using agents. These types of work processes often require a certain level of manual intervention to conduct the analysis due to the subjective nature of the decision making required. In some embodiments, the knowledge required to execute each step can be encoded within the agents.

For example, the well optimization workflow described above might be executed by agents. In this system, an agent can monitor a production database to determine when a new well test has been entered. When a new well test is detected, the agent can initiate one or more actions, for example, including informing one or more other agents that there is a new well test.

One of the agents may be a well-test validation agent that checks the measurements associated with the new well test to determine which choke correlation is most appropriate for the well test. The well-test validation agent will then launch a computer application to calculate the expected well test measurements using the choke correlation selected. The well-test validation agent would then compare the expected well test measurements with the actual well test measurements. The well-test validation agent may then query the production database for the last x months of well tests and generate a trend line for them. The new well test is then compared against the trend line. The well-test validation agent can determine if the well test is valid based on the results of the checks against a choke correlation and historical well tests. If the well test is not valid, the well-test validation agent will make a notation in the production database and may take another action, for example, alerting an engineer and field operations personnel that the well test is bad and a new well test is required, such as through their personal agents. If the well test is valid, then the well-test validation agent would notify a well-optimization agent that a new valid well test is available.

The well-optimization agent may locate the data used to describe the well, such as a file on the WAN or a descriptor in a database, such as WELLVIEW, for the well of interest, and launch a well modeling application. The well modeling application may be performed by a modeling agent, which would return the results when finished. The input data may have been created for a specific well when a well model is created using the well modeling application. As one example, well modeling software can be used to calculate inflow performance relationships (IPR) and vertical lift performance (VLP) curves.

The well-optimization agent may use the well modeling application to calculate an IPR and VLP for the measured well test. The well-optimization agent may also communicate with a modeling agent that performs the calculations. If the well-optimization agent determines that the well test is within a certain tolerance, for example, 5%, 10%, or 20%, of the intersection of the IPR and VLP curve, then the conclusion is that the well model does not need to be calibrated and that the well test is good. If the well test is not within the selected tolerance then the well model may need to be calibrated. The well-optimization agent may make additional runs with the well modeling software to fit a new IPR with the measured well test and VLP curve. Alternatively, a history matching agent may be called on to perform this function. The well-optimization agent may also look in the production database to find out when the most recent bottomhole pressure was run. Under certain conditions, the well-optimization agent may make a recommendation to the engineer and the field personnel to run a new bottomhole pressure survey which can be used to update the well model. If the well model is properly calibrated, then the well-optimization agent would calculate the productivity index for the flowing completion. Using guidelines for the field, the well-optimization agent would determine if the productivity index is acceptable or below average. If the productivity is below average, then the well-optimization agent may inform a team member, for example, through a personal agent, that the well may be a candidate for some type of stimulation.

A second example of a reservoir management process is detecting intentional or unintentional shut-in conditions for a well. This can be performed by detect a well shut-in. A data set for analysis may be selected and filtered. A pressure transient analysis may be performed on the data. An IPR in a well model may be updated with new P* and skin values.

This procedure may be performed using agents. For example, a well monitoring agent may monitor a data historian agent that obtains real-time data streaming from a downhole permanent pressure temperature gauge installed in a well. Based on characteristics of the data plotted against time, the well monitoring agent will identify wells that have been shut-in. Once it has determined that a shut-in has occurred, the well monitoring agent can notify a data preparation agent which may determine which data points are needed for further analysis. The data preparation agent can extract the data set from the data historian and filter and “cleanse” the data. Filtering allows data points to be removed from the data set to reduce the total number of points to be analyzed while maintaining adequate resolution of the data for analysis. Cleansing the data allows for the removal of bad data, such as data spikes indicating sudden increases or decreases, which some pressure or temperature gauges may erroneously record. Once cleansing is completed, the data preparation agent can notify a pressure transient analysis (PTA) agent that there is a data set that requires analysis. The PTA agent will locate the well data on which the analysis will be performed. These data include those entered previously that defines the well model for the application used for PTA. The PTA agent will perform the PTA with the application, for example, using the data set created by the data preparation agent. Human knowledge and judgment may often be required to perform a PTA. However, the analysis may be fully automated within the collection of agents, for example, by encoding the judgments made. In other embodiments, the analysis may include real-time human interaction via the personal agents.

The results of the PTA can then be recorded in the production database, and the PTA agent can notify the well optimization agent that new P* (average reservoir pressure) and skin values are available to update the inflow performance relationship (IPR) in the well model. The well model can be maintained in a separate software application. The well optimization agent then updates the well modeling software with the new values and performs a validation when the next well test is recorded.

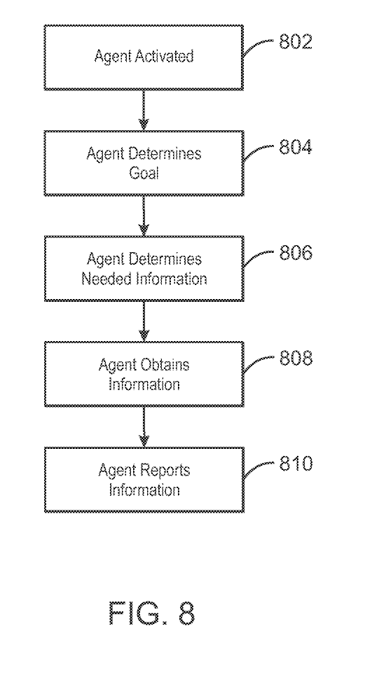

FIG. 8 is a process flow diagram of a method 800 that may be used by an agent, in accordance with an embodiment. The method 800 may begin at block 802 when an agent is activated. For example, referring also to FIG. 3, an IntentionSelector 318 may determine that a plan 310 can be run at a particular time. At block 804, the agent determines the goal, for example, in the plan 310. At block 806, the agent may determine information needed to complete the plan 310. At block 808, the agent may obtain the information, for example, by communicating with other agents to obtain data, run analyses, obtain expert opinions, and the like. At block 810, the agent may report the results, for example, providing the results to personal agents, other agents, and the like.

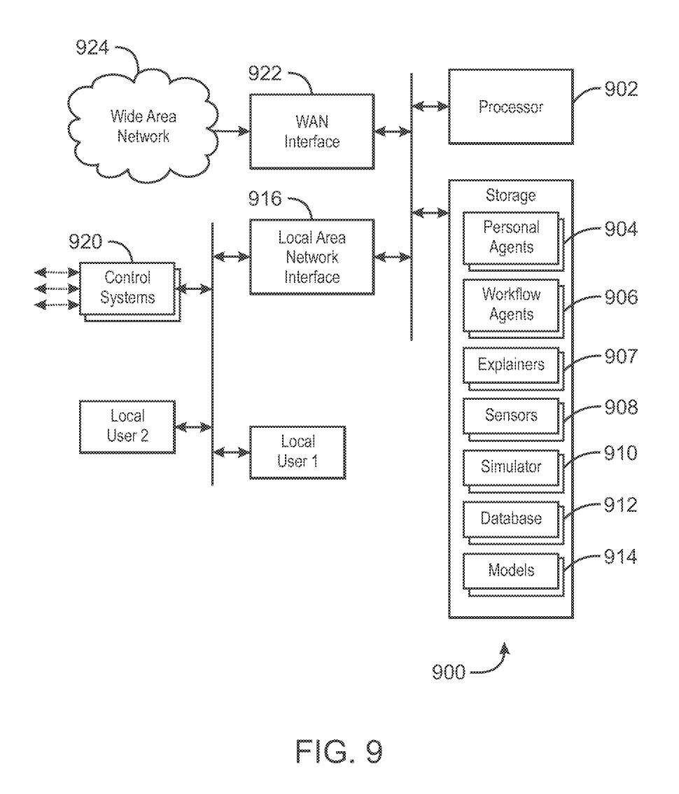

FIG. 9 is a block diagram of a non-transitory computer readable medium 900, in accordance with an embodiment. The non-transitory computer readable medium 900 may include any combinations of random access memory (RAM), read only memory (ROM), hard drives, optical drives, RAM drives, flash memory, flash memory drives, and the like. The non-transitory computer readable medium 900 may store code blocks and functional data structures that can be accessed by a processor 902 and which can direct the processor 902 to perform certain functions. The processor 902 may be a single core processor, a multi-core processor, or a cluster of processors in a cloud computing configuration.

In various embodiments, the code and data blocks may be agents that are instantiated in the non-transitory computer readable medium 900. As discussed above, such agents may include personal agents 904, workflow agents 906, explainer agents 907, sensor agents 908, and others. The agents 904, 906, 907, and 908, may direct the processor to access locally stored simulators 910, databases 912, and models 914, among others. In various embodiments, the agents 904, 906, 907, and 908, may direct the processor 902 to use a LAN interface 916 to access other systems that may exist in a facility, such as user systems 918 or local control systems 920. Further, the agents 904, 906, 907, and 908, may direct the processor to use a WAN interface 922 to access remote systems, for example, systems located in other facilities, which are coupled to a wide area network 924.

While the present techniques may be susceptible to various modifications and alternative forms, the embodiments discussed above have been shown only by way of example. However, it should again be understood that the present techniques are not intended to be limited to the particular embodiments disclosed herein. Indeed, the present techniques include all alternatives, modifications, and equivalents falling within the true spirit and scope of the appended claims.

What is claimed is:

1. A system for managing hydrocarbon assets, comprising:
a computer network associated with a hydrocarbon asset;
a plurality of agents operating on the computer network, wherein at least one agent in the plurality of agents is a workflow agent, wherein the workflow agent comprises:
an operating code configured to direct the operation of the agent;
a goal to be accomplished for the hydrocarbon asset;
a plan to accomplish the goal, wherein the plan is selected by the workflow agent based, at least in part, on a current condition; and
a data store comprising conditions.

2. The system of claim 1, wherein the plurality of agents comprises an asset agent configured to represent the data for the hydrocarbon asset.

3. The system of claim 1, wherein the plurality of agents comprises a personal agent configured to access other agents to obtain information and analysis results for a user.

4. The system of claim 1, wherein the plurality of agents comprises a plurality of personal agents, wherein each of the plurality of personal agents is associated with a member of an asset-management team, and wherein the plurality of personal agents is configured to interact to achieve a goal.

5. The system of claim 4, comprising a new workflow agent instantiated by the plurality of personal agents.

6. The system of claim 1, wherein the plurality of agents comprises a hierarchy of agents operating at different levels of functionality.

7. The system of claim 1, wherein the plurality of agents comprises an explainer.

8. The system of claim 7, wherein the explainer is configured to format results from an analysis and to provide the formatted results of the analysis to another agent or to a human.

9. The system of claim 7, wherein the explainer is configured to recommend actions for managing the hydrocarbon asset.

10. The system of claim 1, wherein the plurality of agents comprises a simulator agent.

11. The system of claim 10, wherein the simulator agent comprises a reservoir model.

12. The system of claim 11, wherein the reservoir model includes surface facilities.

13. The system of claim 10, wherein the simulator agent is configured to interact with a history matching agent.

14. The system of claim 1, comprising a wide-area network coupling a plurality of facility networks.

15. The system of claim 1, wherein an agent is configured to interact with another agent located at a customer facility.

16. The system of claim 1, wherein a workflow agent competes with other agents for resources.

17. The system of claim 1, wherein workflow agents are configured to negotiate with other agents to fulfill goals.

18. The system of claim 1, wherein if the workflow agent is unable to fulfill a goal, it is configured to communicate with a personal agent in order to engage human intervention.

19. A method for managing a hydrocarbon asset, comprising:
creating an interactive community of agents, wherein each agent comprises code and functional data structures;
creating at least one workflow agent, wherein the workflow agent is configured to pursue a plan to accomplish a goal;
providing the workflow agent with detectors to determine environmental conditions;
providing the workflow agent with the ability to communicate with other intelligent agents; and
configuring the workflow agent to select the plan based, at least in part, on information obtained from the detectors.

20. The method of claim 19, comprising providing an analysis agent configured to coordinate a plurality of sensor readings and determine a status of a system.

21. The method of claim 19, comprising providing a personal agent configured to access other agents to obtain information and analysis results for a user.

22. The method of claim 21, comprising configuring a personal agent to interact with other personal agents and with other agents to achieve a goal.

23. The method of claim 19, comprising:
providing an explainer agent; and
configuring the explainer agent to analyze data and provide results of the analysis to another software agent or to a human.

24. The method of claim 23, comprising configuring the explainer to provide recommended actions.

25. The method of claim 19, comprising
providing a simulator agent; and
configuring the simulator agent to access a model.

26. The method of claim 25, comprising configuring the simulator agent to interact with a history matching agent.

27. A non-transitory computer readable medium comprising code and data structures comprising:
a personal agent configured to represent a user;
an explainer configured to format data and results;
a workflow agent configured to obtain data and results needed to achieve a goal for a user; and
a sensor agent configured to obtain physical or market data for use by other agents.

28. The non-transitory computer readable medium of claim 27, comprising a data store used to hold data for a facility.

29. The non-transitory computer readable medium of claim 28, wherein the data store comprises best practices for operating an asset.

30. The non-transitory computer readable medium of claim 27, comprising a simulator.

31. The non-transitory computer readable medium of claim 27, comprising a model.
